(19) United States
(12) Patent Application Publication
(10) Pub. No.: US 2012/0061283 A1
(43) Pub. Date: Mar. 15, 2012

(54) Privacy information securing bagging case

(76) Inventor: Rafik Behman, Tarpon Springs, FL (US)

(21) Appl. No.: 13/373,437

(22) Filed: Nov. 14, 2011

Related U.S. Application Data
(63) Continuation of application No. 12/012,448, filed on Feb. 4, 2008.

(51) Int. Cl. A61J 1/14; A61J 1/16

(52) U.S. Cl. 206/534

(57) ABSTRACT

The present invention represents a new kind of invention that serves an urgent market need; it is a new printable bagging case; used for both information printing and bagging of an item; it is a printable sheet or multi sheet folder designed as a bag; It has a big value for some business; such as pharmacy business where printing drug information and bagging it are two separate steps; which takes a lot of the pharmacist time and efforts that may increase the pharmacy business coast; It is intended to save at least 30% of the pharmacist time.

### RELATED APPLICATIONS

This Application claims the priority of the Non-Provisional Application: Ser. No. 12/012,448, Filed Feb. 4, 2008, Entitled “Privacy Information Securing Bagging Case”

### FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention features a new invention that serves a new purpose; it is the first of its kind; intended to combine two separate steps in one;

It is used for information printing and bagging of an item; whereas:

Printing item information is one step;

Bagging the item is a second step;

Both printing and bagging steps involve paper work that can be combined into one step;

This invention is intended to combine information printing and bagging of an item;

It is a printable bagging case; printable sheet or multi sheet folder designed as a bag;

So that the sheet or folder can be first printed with the item information; and then used for bagging the item

It is a new kind of printable folder that is also used for bagging;

2. Discussion of the Prior Art

The US patent to Arnold B, Bloch; Gilbert [U.S. Pat. No. 6,652,984] is for a paper laminate sheeting capable of being converted by conventional equipment into envelops, grocery bags and other deflatable container products that initially are in flat state and are normally made of paper;

This is a process of producing a preprinted core of bags that are later cut to provide separate preprinted bags is different from the present invention since it is for instant printing of different information specific for each item or drug

### BRIEF SUMMARY OF THE INVENTION

I am a pharmacist; and my job requires that I visually verify and match the dispensed drug with the picture of the prescribed drug on the computer screen and make sure they both the same;

After that I click accept; by clicking accept the printer would print a paper that contains both patient information and drug information;

The patient information part is to identify the right patient; and the drug information part is specific for each drug and is private information

First I have to tear off the patient information part from the drug information part;

Second I have to fold the drug information part and make it fit inside a bag;

Third I have to insert the folded drug information part with the dispensed drug into the bag;

Forth I have to staple the patient information part to the bag; for patient identification purposes and make sure that the bag is stapled and sealed;

This process takes a lot of pharmacist time and effort; and is also subject to mistakes;

I thought of an idea that would combine both information printing and bagging of an item or a drug with securing its privacy information if required; an idea that would save time and effort of the pharmacist;

I thought of Privacy Information Securing Bagging Case;

It is an object of the invention that the pharmacist or other beneficiary to use the privacy information securing bagging case to combine both information printing and bagging of an item or a drug in one single step; to avoid the unnecessary steps of tearing, folding, inserting and stapling of the printed information paper; necessary for bagging the item;

It is further objective of the invention that the pharmacist or other beneficiary uses the privacy information securing bagging case to avoid tearing printed paper to separate different information parts;

It is further objective of the invention that the pharmacist or other beneficiary uses the privacy information securing bagging case to avoid folding printed paper to fit inside a bag;

It is further objective of the invention that the pharmacist or other beneficiary uses the privacy information securing bagging case to avoid inserting the folded part of the printed paper into a bag.

It is further objective of the invention that the pharmacist or other beneficiary uses the privacy information securing bagging case to avoid stapling a patient or a person information label to a bag.

It is further objective of the invention that the pharmacist or other beneficiary uses the privacy information securing bagging case to save time and effort.

It is further objective of the invention that the pharmacist or other beneficiary uses the privacy information securing bagging case to avoid mistakes involved in the two separate steps; printing specific item information and bagging the same item; such as switching two different patient information labels.

### BRIEF DESCRIPTION OF THE SEVERAL VIEWS OF THE DRAWING

FIGS. 1, 2 and 3 are plan views of a single first section and varying numbers of second section folders.

FIGS. 4, 5 and 6 are perspective views of a single first section and varying numbers of second section folders.

FIG. 7 is a perspective illustration of one sheet of the privacy information securing bagging case system prior to fabrication.

FIG. 8 is a perspective illustration of the privacy information securing bagging case with the bag structure.

FIG. 9 is a perspective illustration similar to FIG. 8 but after being folded.

FIG. 10 is a perspective illustration of the privacy information securing bagging case system after receiving patient-drug information and while receiving a dispensed drug

FIG. 11 is a perspective illustration of the privacy information securing bagging case system after receiving a dispensed drug and after being stapled;

### DESCRIPTION OF THE PREFERRED EMBODIMENT OF THE INVENTION

The privacy information securing bagging case consists of:

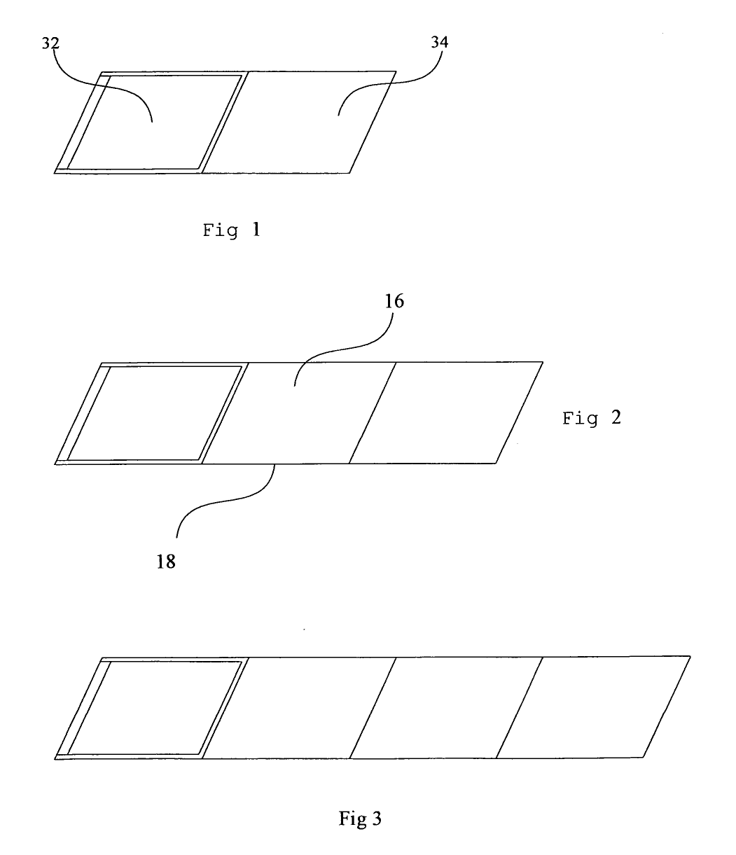

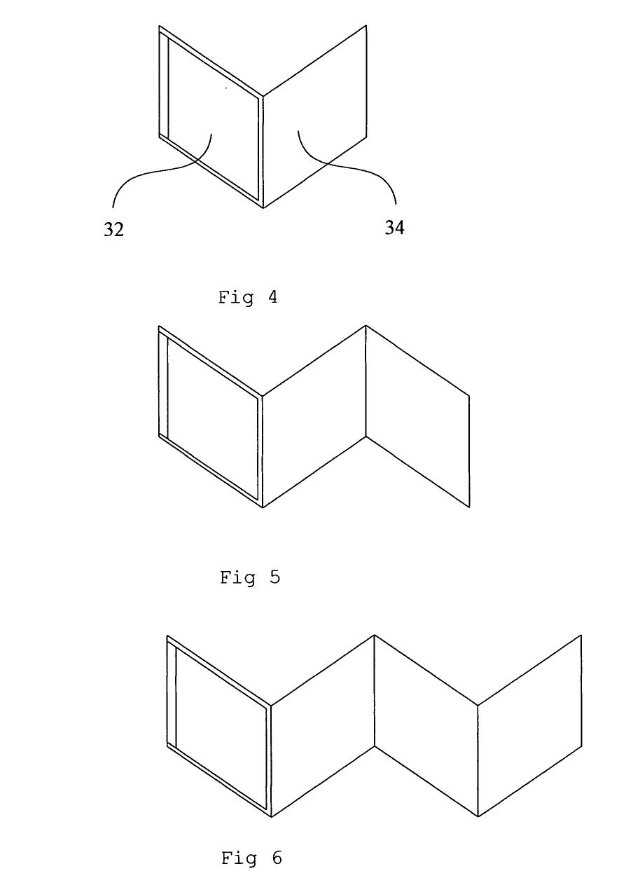

Two sections folder; (32) and (34) of FIG. 1

Three sections folder; FIG. 2

Four sections folder; FIG. 3

At least one of the folder faces left blank for printing purposes; (18) FIG. 2

The other face may be preprinted with an advertisement, privacy agreement or any other issue; (16) of FIG. 2

One of the folder sections is partially or totally designed as a bag; (32) of FIG. 1,

This section (32) is double walled with at least one open side designed as a bag,

So that when in use folders are used in place of the printer papers; placed one on top of the other;

The pharmacist would match the dispensed drug with the picture of the prescribed drug as mentioned before and click accepts; the printer would print the patient information and the drug information on the blank face of the multi sections folder;

The pharmacist would then insert the dispensed drug into the bag designed section (32) of the folder; and he would fold the whole sheet sections with each other; with the printed faces facing each other from inside; so that the information of the drug is hidden if required to be private;

The pharmacist would then seal or staple the bag designed section with other sections of the foldable sheet;

One of the foldable sheet sections may have wider margins so that some of the folded printed sections information becomes visible if required;

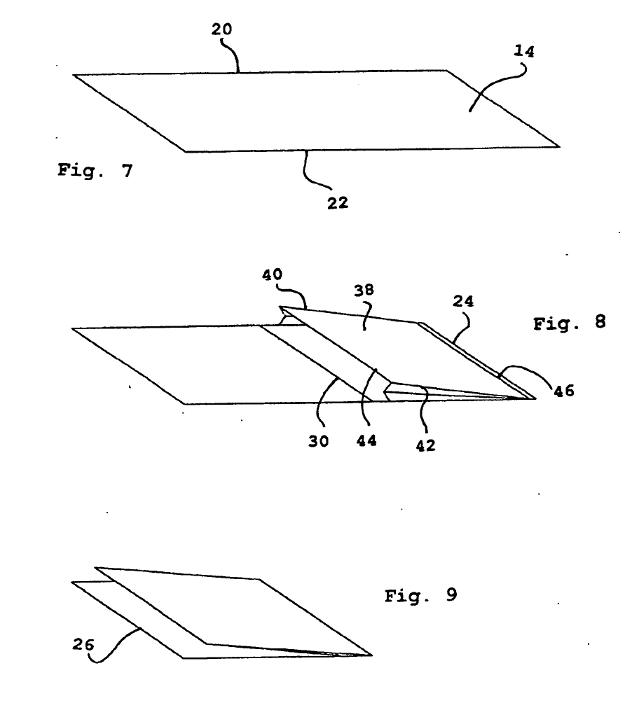

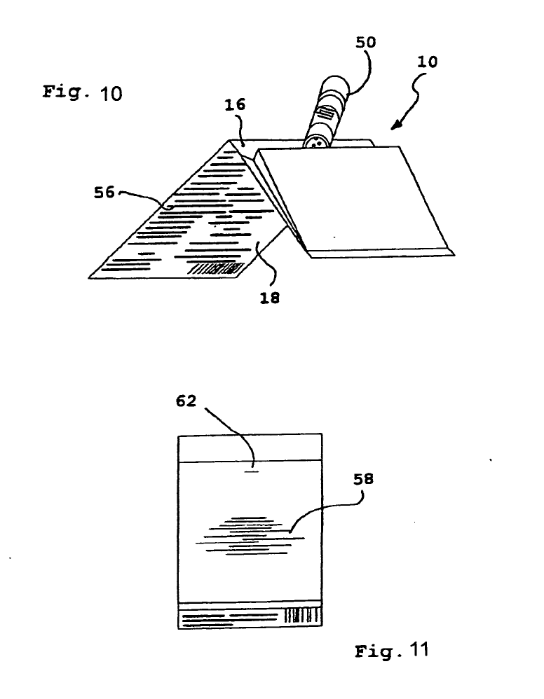

Referring now to the drawings, in FIGS. 7, 8, 9, 10 and 11.

First provided in the privacy information securing bagging case system (10) of the present invention is:

A sheet (14) of printable paper, the sheet having an upper face (16) and a lower face (18), the sheet having a horizontal upper edge (20) and a parallel lower edge (22) separated by a height, the sheet having a vertical first side edge (24) and a parallel second side edge (26) separated by a Length.

A vertically spaced fold line (30) located between and parallel with the first and second side edges, the vertical fold line dividing the sheet into a first section (32) and a second section (34), each of the sections being in a rectangular configuration with the second section having wider margins than the first section.

A folder sheet (38), the folder sheet overlying the upper face of the first section of the sheet, the folder sheet being rectangular, the folder sheet having an upper horizontal peripheral edge (40) and a lower horizontal peripheral edge (42), the folder sheet having an interior vertical peripheral edge (44) and an exterior vertical peripheral edge (46), the upper and lower horizontal peripheral edges and the exterior vertical peripheral edge being coupled to the first section with the folder sheet and the first section of the sheet forming a bag with an opening at the interior vertical edge of the folder sheet.

The upper face of the sheet adapted to be previously printed with different standard business issues (58).

Second section lower face of the sheet being blank for the receipt of specific patient-drug information printing (56) related to a dispensed drug to be bagged.

Sheet being foldable with the first and second sections lower faces in contact for the specific patient-drug information printing to be hidden and private.

A portion of the second section lower face specific patient-drug information printing is exposed due to the smaller size of first section with respect to the second section.

Next provided a dispensed drug (50) movable through the bag opening into a location inside the bag.

Lastly, a staple (62) closes the bag opening and couples the first and second sections of the sheet together.

What is claimed is:

1. Privacy information securing bagging case system comprising:
a printable sheet having upper and lower faces, the sheet having horizontal upper and lower edges separated by a height, the sheet having a vertical first and second side edges separated by a length,
at least one said vertically spaced fold line located between and parallel with said side edges and dividing the sheet into a first section and at least one second section, each of the sections being in a rectangular configuration, said at least second section having wider margins than said first section,
said first section of the sheet having a bag structure for the receipt and bagging of a dispensed drug,
said upper face of the sheet adapted to be previously printed with different standard business issues, and
said at least second section lower face of the sheet being blank for the receipt of specific patient-drug information printing related to a dispensed drug to be bagged,
sheet foldable with the lower sections faces in contact for the specific patient-drug information printing to be hidden and private,
a portion of the second section lower face specific patient-drug information exposable due to wider margins of the second section with respect to the first section,
lastly, a staple closes the bag opening and couples the sheet sections together.

2. Privacy information securing bagging case system comprising:
a sheet (14) of printable paper, the sheet having an upper face (16) and a lower face (18), the sheet having a horizontal upper edge (20) and a parallel lower edge (22) separated by a height, the sheet having a vertical first side edge (24) and a parallel second side edge (26) separated by a Length,
a vertically spaced fold line (30) located between and parallel with the first and second side edges, the vertical fold line dividing the sheet into a first section (32) and a second section (34), each of the sections being in a rectangular configuration with the second section having wider margins than the first section,
a folder sheet (38), the folder sheet overlying the upper face of the first section of the sheet, the folder sheet being rectangular, the folder sheet having an upper horizontal peripheral edge (40) and a lower horizontal peripheral edge (42), the folder sheet having an interior vertical peripheral edge (44) and an exterior vertical peripheral edge (46), the upper and lower horizontal peripheral edges and the exterior vertical peripheral edge being coupled to the first section with the folder sheet and the first section of the sheet forming a bag with an opening at the interior vertical edge of the folder sheet, for the receipt and bagging of a dispensed drug,
the upper face of the sheet adapted to be previously printed with different standard business issues(58),
the lower face of the second section being blank for the receipt of specific information printing (56) related to a dispensed drug to be bagged,
